(19) United States
(12) Patent Application Publication
(10) Pub. No.: US 2016/0017646 A1
(43) Pub. Date: Jan. 21, 2016

(54) Door Latch Device

(71) Applicant: I-Tek Metal Mfg. Co., Ltd., Tainan (TW)

(72) Inventor: Hsi-Ting Lin, Tainan (TW)

(21) Appl. No.: 14/334,708

(22) Filed: Jul. 18, 2014

(51) Int. Cl. E05C 1/08

(52) U.S. Cl. CPC E05C 1/08

(57) ABSTRACT

A door latch device includes a positioning seat having a positioning portion mounted to a top end or a bottom end of a door. The positioning portion includes a sliding groove having a sidewall with first and second insertion grooves. An actuation block includes a head and a body. The body is slideably received in the sliding groove.

The body includes a receptacle. A ball is received in the receptacle of the actuation block and is biased by a spring. A latch is fixed to and jointly moveable with the actuation block between a latching position and an unlatching position corresponding to the locations of the first insertion groove and the second insertion groove. When the latch is in the latching or unlatching position, the spring biases the ball into a corresponding one of the first and second insertion grooves to retaining the latch in the latching or unlatching position.

### BACKGROUND OF THE INVENTION

The present invention relates to a door latch device and, more particularly, to a door latch device for rapidly and precisely positioning a latch in a latching or unlatching position.

Top latch and Bottom latch mounted on top and bottom ends of a door have many common components, including a positioning seat mounted to the top or bottom end of the door and a latch extending through the positioning seat. The positioning seat includes a longitudinally extending sliding groove having a sidewall with two insertion grooves. The latch is slideably received in the sliding groove and includes a manually operable knob. A user can grip the knob to vertically move the latch into or out of a latch hole in a door frame and then pivot the knob into one of the insertion grooves to retain the latch in a latching position or an unlatching position, allowing the door to be opened or retaining the door in the closed position.

However, the user cannot rapidly and precisely move the knob into the desired insertion groove. In a dark environment, the user has to try many times until the knob is aligned with and, thus, can be moved into the desired insertion groove, which is extremely inconvenient in use. Furthermore, since the latch cannot be retained in a place between the latching and unlatching positions, in a case that the user intends to open the door by moving the knob out of the insertion groove and then vertically moving the latch, an end of the latch will impinge an inner periphery of the latch hole in the door frame and, thus, enlarge the latch hole if the door is inadvertently pivoted while the latch has not completely been moved out of the latch hole. If the latch deforms due to the impingement, the latch will no longer be able to align with the latch hole, causing difficulties in subsequent operation (namely, the latch cannot be moved into the latch hole by a single step).

Thus, a need exists for a novel door latch device for rapidly and precisely positioning a latch in a latching or unlatching position.

### BRIEF SUMMARY OF THE INVENTION

The present invention solves this need and other problems in the field of latches by providing a door latch device including a positioning seat having a positioning portion with an outer surface and an inner surface spaced from the outer surface in a first direction. The positioning portion includes a sliding groove extending from the outer surface through the inner surface. The sliding groove includes a sidewall having a first insertion groove and a second insertion groove spaced from the first insertion groove in a second direction perpendicular to the first direction. The positioning portion is adapted to be mounted to a top end or a bottom end of a door. An actuation block includes a head and a body. The body includes a receptacle. The body is received in the sliding groove of the positioning portion and is slideable in the second direction. The inner surface of the positioning portion of the positioning seat faces away from the head of the actuation block. A ball is received in the receptacle of the actuation block. A spring is received in the receptacle of the actuation block and is located between a bottom wall of the receptacle and the ball. A latch is fixed to and jointly moveable with the actuation block. The latch includes a latch head having an operative end. The latch is moveable between a latching position and an unlatching position spaced from the latching position in the second direction.

When the latch is in the latching position, the operative end protrudes out of the positioning seat, the receptacle is aligned with the first insertion groove, and the spring biases the ball to extend into and engage with the first insertion groove, retaining the latch in the latching position.

When the latch is in the unlatching position, the operative end does not protrude beyond the positioning seat, the receptacle is aligned with the second insertion groove, and the spring biases the ball to extend into and engage with the second insertion groove, retaining the latch in the unlatching position.

When the latch slides between the latching position and the unlatching position, the ball slides along the sidewall of the sliding groove between the first and second insertion grooves.

In an embodiment, the outer surface of the positioning portion includes a recessed portion. The sliding groove is located in the recessed portion. T head of the actuation block is received in the recessed portion and does not extend beyond the outer surface of the positioning portion of the positioning seat. The latch further includes a plate. A fixing portion extends perpendicularly from an end of the plate. The latch head includes an engagement end fixed to the fixing portion and spaced from the operative end. The positioning seat further includes a coupling portion extending perpendicularly from an end of the positioning portion. The coupling portion has a hole. The coupling portion is adapted to be fixed to a top face or a bottom face of the door. The coupling portion is adapted to be fixed to an end face of the door extending between the top face and the bottom face of the door. The latch is slideably received in the hole.

The present invention will become clearer in light of the following detailed description of illustrative embodiments of this invention described in connection with the drawings.

### DESCRIPTION OF THE DRAWINGS

The illustrative embodiments may best be described by reference to the accompanying drawings where:

FIG. 1 is an exploded, perspective view of a door latch device according to the present invention.

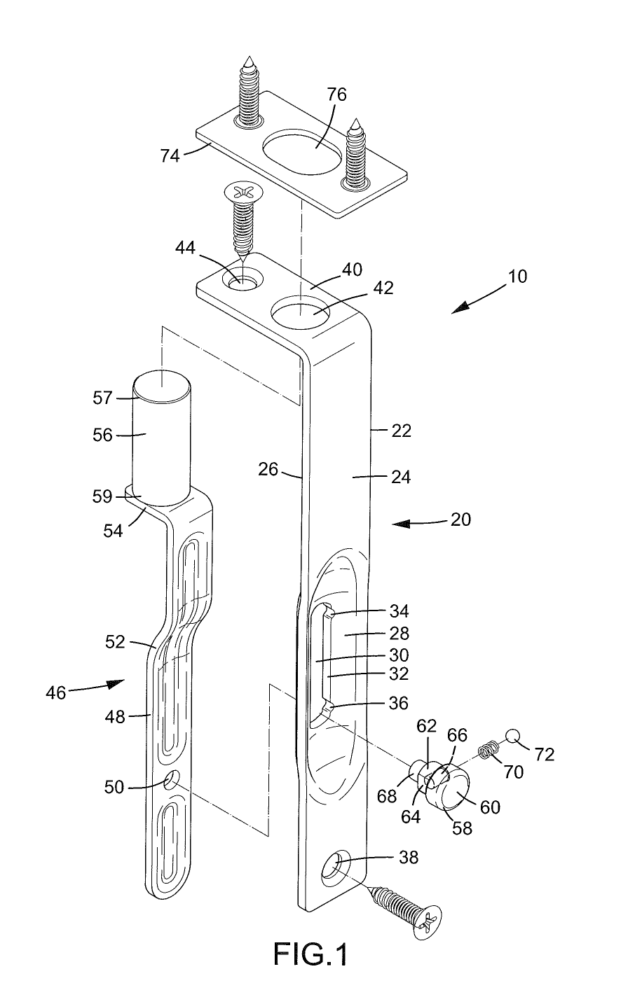

FIG. 2 shows a perspective view of the door latch device of FIG. 1 and a portion of a first door of a double door to which the door latch device is mounted.

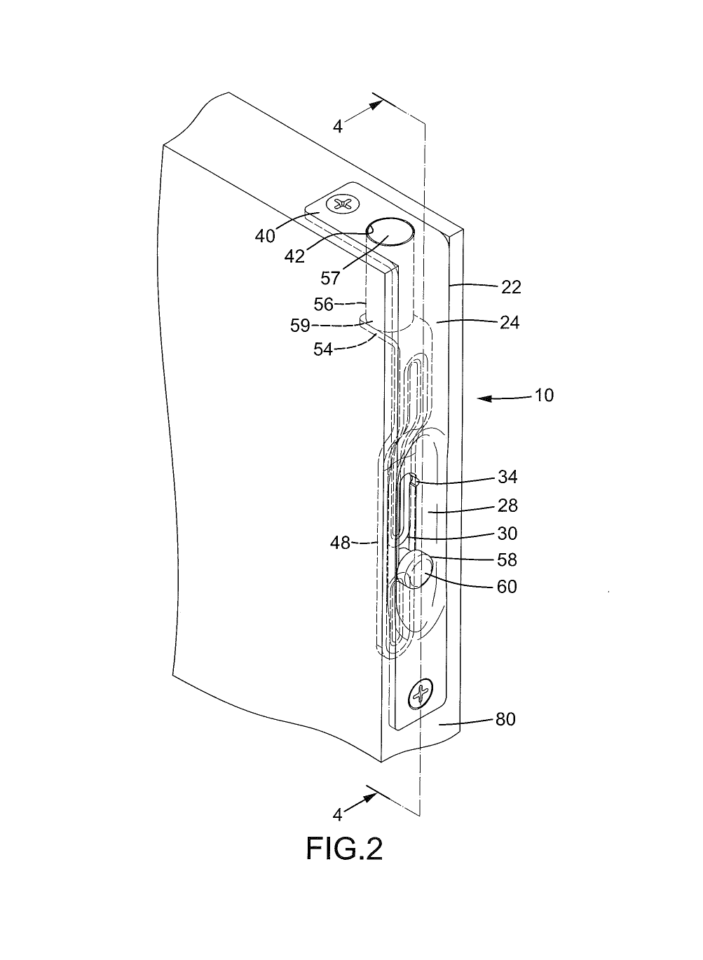

FIG. 3 is a front, elevational view of the double door to which the door latch device of FIG. 1 is mounted.

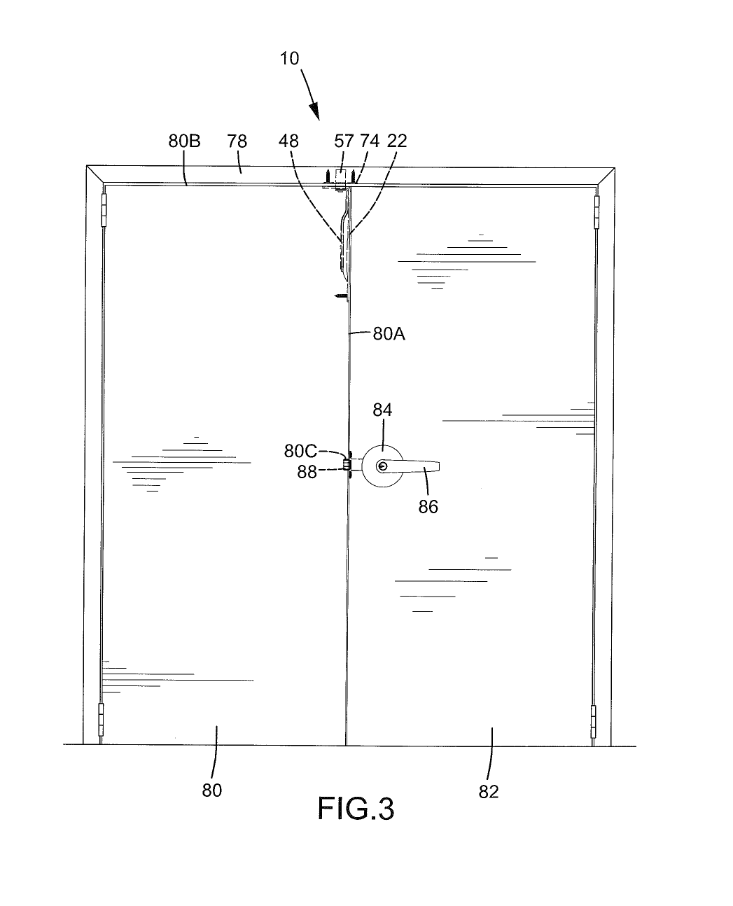

FIG. 4 is a cross sectional view taken along section line 4-4 of FIG. 2, with a latch of the door latch device in an unlatching position.

FIG. 5 is a cross sectional view taken along section line 5-5 of FIG. 4.

FIG. 6 is a cross sectional view taken along section line 6-6 of FIG. 4.

FIG. 7 is a cross sectional view similar to FIG. 6, with the latch moved away from the unlatching position.

FIG. 8 is a view similar to FIG. 4, with the latch moved to a latching position.

FIG. 9 is a cross sectional view taken along section line 9-9 of FIG. 8.

All figures are drawn for ease of explanation of the basic teachings only; the extensions of the figures with respect to number, position, relationship, and dimensions of the parts to form the illustrative embodiments will be explained or will be within the skill of the art after the following teachings have been read and understood. Further, the exact dimensions and dimensional proportions to conform to specific force, weight, strength, and similar requirements will likewise be within the skill of the art after the following teachings have been read and understood.

Where used in the various figures of the drawings, the same numerals designate the same or similar parts. Furthermore, when the terms “first”, “second”, “top”, “bottom”, “side”, “end”, “portion”, “section”, “horizontal”, “vertical”, and similar terms are used herein, it should be understood that these terms have reference only to the structure shown in the drawings as it would appear to a person viewing the drawings and are utilized only to facilitate describing the illustrative embodiments.

### DETAILED DESCRIPTION OF THE INVENTION

A door latch device according to the present invention is shown in the drawings and generally designated 10. The door latch device 10 can be mounted to a double door or a single door. In the form shown, the door latch device 10 is mounted to a double door mounted to a door frame 78 and including a first door 80 and a second door 82. The first door 80 includes a top face 80B, a bottom face opposite to the top face 80B, and an end face 80A extending between the top face 8013 and the bottom face. A groove 80C is defined in the end face 80A. A latch plate 74 is fixed to a bottom face of a horizontal section of the door frame 78 and includes a positioning hole 76 aligned with a latch hole 78A in the door frame 78.

A door lock 84 is mounted to the second door 82 and is operable by a handle 86. The door lock 84 includes a latch bolt 88 received in the groove 80C of the first door 80. The latch bolt 88 can be retracted by pivoting the handle 86. Other types of the door lock 84 can be used.

The door latch device 10 includes a positioning seat 20 having a positioning portion 22. The positioning portion 22 includes an outer surface 24 and an inner surface 26 spaced from the outer surface 24 in a first direction. In the form shown, the outer surface 24 of the positioning portion 22 includes a recessed portion 28. A sliding groove 30 extends from the outer surface 24 through the inner surface 26 and is located in the recessed portion 28. The sliding groove 30 includes two sidewalls 32. One of the sidewalls 32 includes a first insertion groove 34 and a second insertion groove 36 spaced from the first insertion groove 34 in a second direction perpendicular to the first direction. In the form shown, the second direction is the vertical direction perpendicular to a floor or the ground on which the door frame 78 is located. A through-hole 38 extends from the outer surface 24 through the inner surface 26. The positioning portion 22 is adapted to be mounted to a top end or a bottom end of the first door 80 and is adapted to be fixed to the end face 80A of the first door 80. As an example, a screw extends through the through-hole 38 of the positioning portion 22 into the end face 80A of the first door 80.

In the form shown, the positioning seat 20 further includes a coupling portion 40 extending perpendicularly from an end of the positioning portion 22. The coupling portion 40 has a hole 42 and a through-hole 44. The recessed portion 28 is located between the coupling portion 40 and the through-hole 38. The coupling portion 40 is adapted to be fixed to the top face 80B or the bottom face of the first door 80. As an example, a screw extends through the through-hole 44 into the top face 80B of the first door 80.

The door latch device 10 further includes an actuation block 58 received in the recessed portion 28. In the form shown, the actuation block 58 includes a body 62 and a head 60 on an end of the body 62. The head 60 has a diameter larger than a diameter of the body 62. A coupling section 68 extends from the other end of the body 62. The body 62 further includes two chamfered faces 64. The body 62 is received in the sliding groove 30 of the positioning portion 22 and is slideable in the second direction, with the chamfered faces 64 slideably abutting the sidewalls 32 and with the inner surface 26 of the positioning seat 20 facing away from the head 60 of the actuation block 58. Thus, the actuation block 58 will not rotate relative to the positioning portion 22 when the actuation block 58 slides along the sliding groove 30. Furthermore, the coupling section 68 is located outside of the inner surface 26 of the positioning portion 22. The body 62 further includes a receptacle 66 in one of the chamfered faces 64. A ball 72 is received in the receptacle 66 of the actuation block 58. A spring 70 is received in the receptacle 66 of the actuation block 58 and is located between a bottom wall of the receptacle 66 and the ball 72. In the form shown, the head 60 of the actuation block 58 is received in the recessed portion 28 and does not extend beyond the outer surface 24 of the positioning portion 22 of the positioning seat 20.

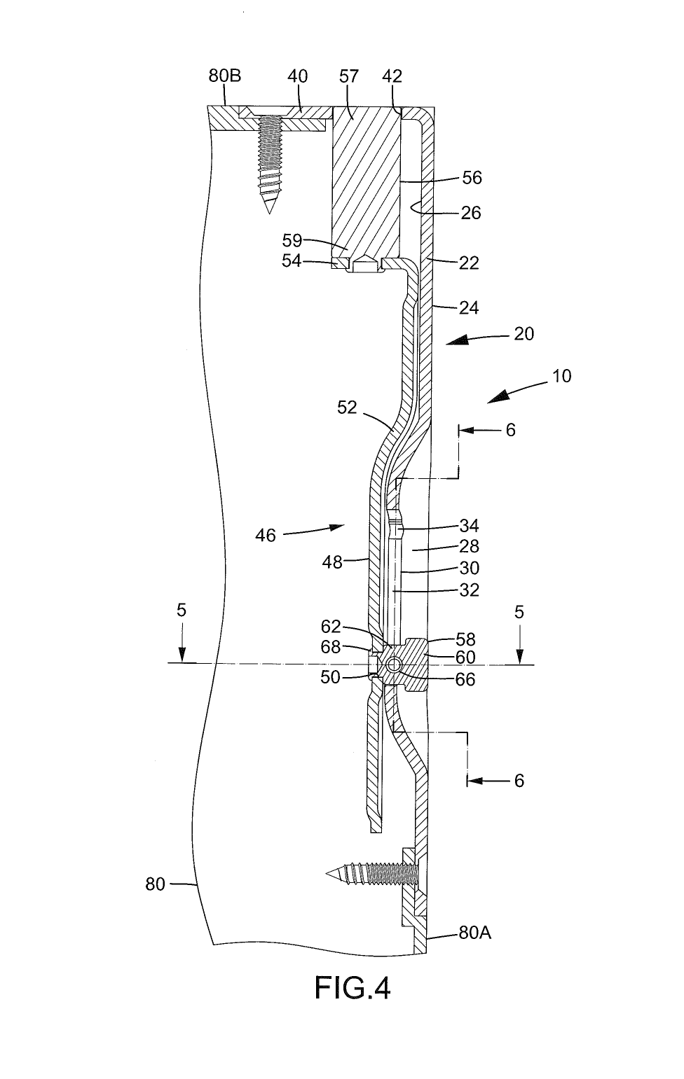

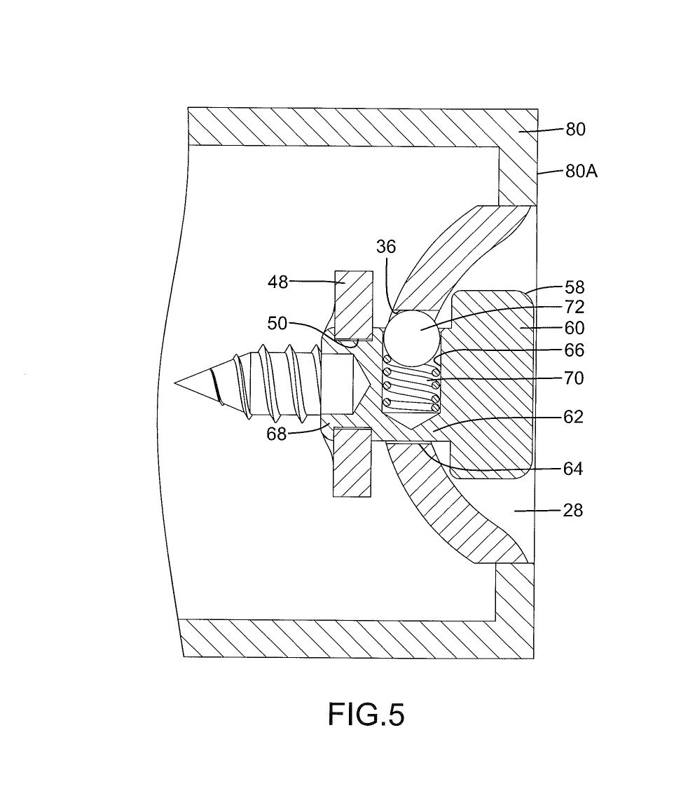

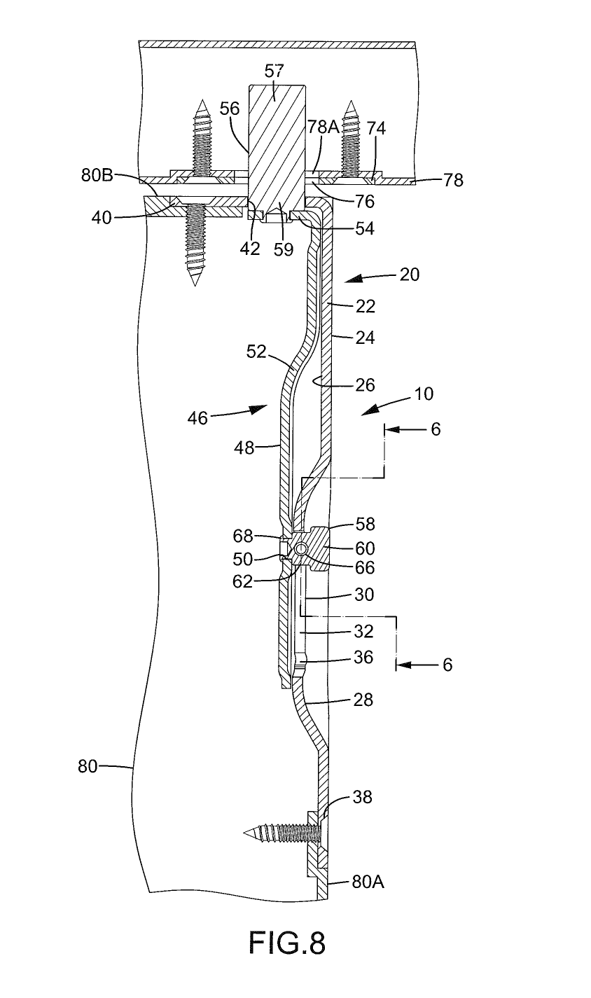

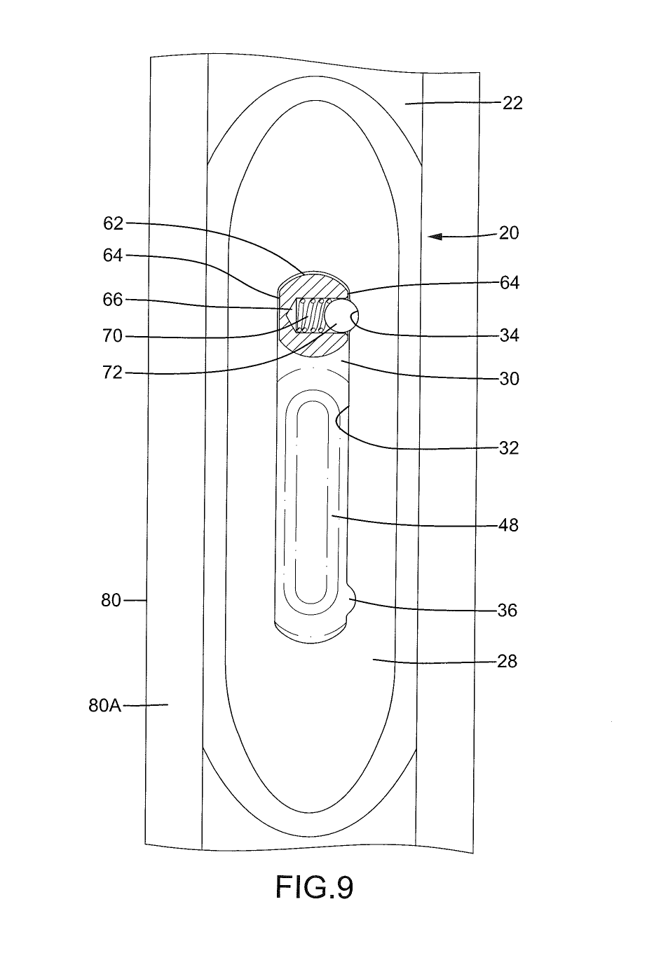

According to the form shown, a latch 46 is fixed to and jointly moveable with the actuation block 58. The latch 46 includes a latch head 56 and a plate 48. The plate 48 includes an engagement hole 50. The plate 48 further includes a bend 52 in a location corresponding to the recessed portion 28. A fixing portion 54 extends perpendicularly from an end of the plate 48. The latch head 56 includes an engagement end 59 fixed to the fixing portion 54 and an operative end 57 spaced from the engagement end 59. The latch 46 is moveable between a latching position and an unlatching position spaced from the latching position in the second direction. The plate 48 abuts the inner surface 26 of the positioning portion 22. The coupling section 68 is riveted in the engagement hole 50 of the plate 48. The operative end 57 of the latch head 56 is slideably received in the hole 42 of the coupling portion 40. Thus, the actuation block 58 moves jointly with the latch 46 between the latching position (FIGS. 8 and 9) and the unlatching position (FIGS. 4 and 5) respectively corresponding to the locations of the first and second insertion grooves 34 and 36.

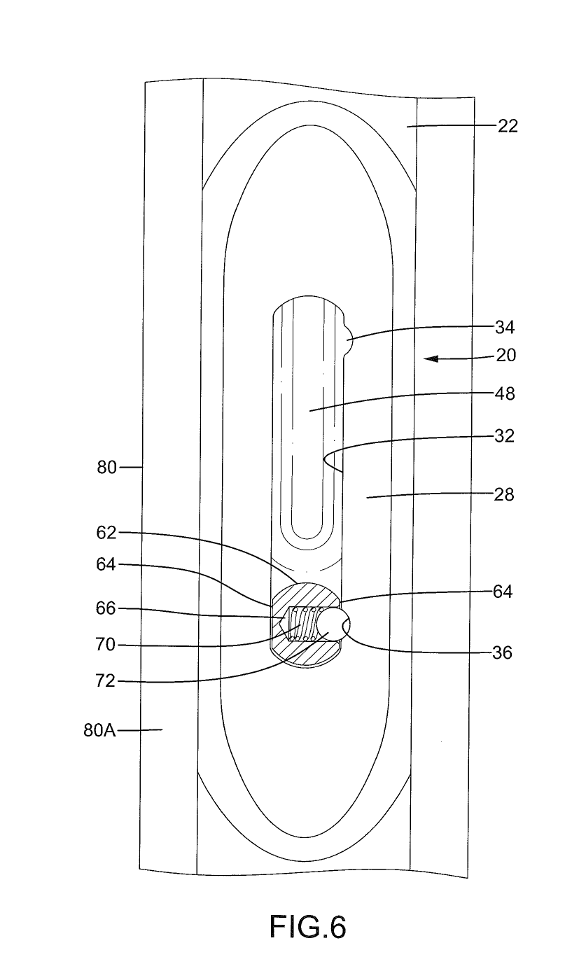

Now that the basic construction of the door latch device 10 of the present invention has been explained, the operation and some of the advantages of the door latch device 10 can be set forth and appreciated. In particular, for the sake of explanation, it will be assumed that the first door 80 is not in the closed position, and the latch 46 is in the unlatching position (FIG. 4). The spring 70 biases the ball 72 into the second insertion groove 36 (FIGS. 5 and 6). In this case, the operative end 57 of the latch head 56 does not protrude beyond the top face 80B of the first door 80. Namely, the receptacle 66 is aligned with the second insertion groove 36, and the latch 46 is retained in the unlatching position. Furthermore, the latch head 56 is spaced from the latch hole 78A of the door frame 78 in a circumferential direction about a pivoting axis of the first door 80. Thus, the first door 80 can pivot from the non-closed position to the closed position.

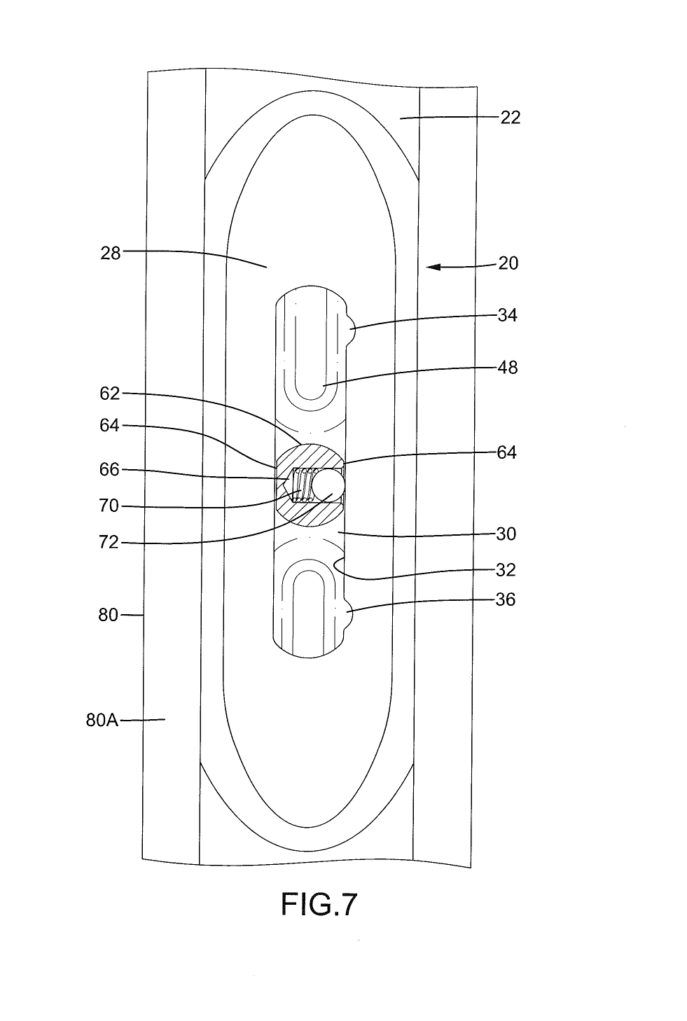

When the first door 80 is pivoted to the closed position, the latch head 56 is aligned with the latch hole 78A of the door frame 78. The actuation block 58 can be moved upward to move the latch 46 from the unlatching position toward the latching position. The ball 72 is pressed inward into the receptacle 66 by the corresponding sidewall 32 and compresses the spring 70, as shown in FIG. 7. Note that when the latch 46 slides between the latching position and the unlatching position, the ball 72 slides along the corresponding sidewall 32 of the sliding groove 30 between the first and second insertion grooves 34 and 36.

After the latch 46 reaches the latching position, the operative end 57 of the latch head 56 passes through the positioning hole 76 in the latch plate 74 into the latch hole 78A of the door frame 78. The ball 72 is aligned with the first insertion groove 34 and is biased by the spring 70 into the first insertion groove 34, retaining the latch 46 in the latching position. Thus, the first door 80 is retained in the closed position. Then, the second door 82 is moved to its closed position parallel to the first door 80. The latch bolt 88 extends into the groove 80C of the end face 80A of the first door 80. Thus, the double door closes a passage defined by the door frame 78. In this state, the actuation block 58 is located between the first and second doors 80 and 82 and, thus, cannot be picked.

If it is desired to open the first and second doors 80 and 82, the handle 86 is operated to retract the latch bolt 88 of the door lock 84 from the groove 80C of the first door 80, and the second door 82 is then opened to reveal the end face 80A of the first door 80. Then, the actuation block 58 can be moved to move the latch 46 from the latching position to the unlatching position to allow subsequent opening of the first door 80.

The latch 46 in the latching position or the unlatching position can rapidly and automatically be retained in place by using the spring 70 to bias the ball 72 into the first insertion groove 34 or the second insertion groove 36, which is convenient in use. The disadvantages of the conventional latch (including difficulties in finding the locations of the latching and unlatching positions and undesired impingement of the latch and the resultant deformation of the latch hole receiving the latch). Furthermore, the actuation block 58 received in the recessed portion 28 does not protrude beyond the first door 80, avoiding potential injury to passersby.

Now that the basic teachings of the present invention have been explained, many extensions and variations will be obvious to one having ordinary skill in the art.

For example, the positioning seat 20 does not have to include the coupling portion 40 and the positioning portion 22 without adversely affecting the biasing function of the spring 70 on the ball 72. Furthermore, the plate 48 of the latch 46 is light. The fixing portion 54 and the plate 48 can be of a rectilinear structure.

Thus since the illustrative embodiments disclosed herein may be embodied in other specific forms without departing from the spirit or general characteristics thereof, some of which forms have been indicated, the embodiments described herein are to be considered in all respects illustrative and not restrictive. The scope is to be indicated by the appended claims, rather than by the foregoing description, and all changes which come within the meaning and range of equivalency of the claims are intended to be embraced therein.

1. A door latch device comprising:
a positioning seat including a positioning portion having an outer surface and an inner surface spaced from the outer surface in a first direction, with the positioning seat including a sliding groove extending from the outer surface through the inner surface, with the sliding groove including a sidewall having a first insertion groove and a second insertion groove spaced from the first insertion groove in a second direction perpendicular to the first direction, with the positioning portion adapted to be mounted to a top end or a bottom end of a door;
an actuation block including a head and a body, with the body including a receptacle, with the body received in the sliding groove of the positioning portion and slideable in the second direction, with the inner surface of the positioning portion of the positioning seat facing away from the head of the actuation block;
a ball received in the receptacle of the actuation block;
a spring received in the receptacle of the actuation block and located between a bottom wall of the receptacle and the ball;
a latch fixed to and jointly moveable with the actuation block, with the latch including a latch head having an operative end, with the latch moveable between a latching position and an unlatching position spaced from the latching position in the second direction;
wherein when the latch is in the latching position, the operative end protrudes out of the positioning seat, the receptacle is aligned with the first insertion groove, and the spring biases the ball to extend into and engage with the first insertion groove, retaining the latch in the latching position,
wherein when the latch is in the unlatching position, the operative end does not protrude beyond the positioning seat, the receptacle is aligned with the second insertion groove, and the spring biases the ball to extend into and engage with the second insertion groove, retaining the latch in the unlatching position, and
wherein when the latch slides between the latching position and the unlatching position, the ball slides along the sidewall of the sliding groove between the first and second insertion grooves.

2. The door latch device as claimed in claim 1, with the outer surface of the positioning portion includes a recessed portion, with the sliding groove located in the recessed portion, and with the head of the actuation block received in the recessed portion and not extending beyond the outer surface of the positioning portion of the positioning seat.

3. The door latch device as claimed in claim 2, with the latch further including a plate, with a fixing portion extending perpendicularly from an end of the plate, with the latch head including an engagement end fixed to the fixing portion and spaced from the operative end, with the positioning seat further including a coupling portion extending perpendicularly from an end of the positioning portion, with the coupling portion having a hole, with the coupling portion adapted to be fixed to a top face or a bottom face of the door, with the coupling portion adapted to be fixed to an end face of the door extending between the top face and the bottom face of the door, and with the latch slideably received in the hole.
